(19) United States
(12) Patent Application Publication
(10) Pub. No.: US 2011/0092154 A1
(43) Pub. Date: Apr. 21, 2011

(54) RADIO COMMUNICATION DEVICE

(75) Inventors: Ayako Horiuchi, Kanagawa (JP); Seigo Nakao, Kanagawa (JP); Katsuhiko Hiramatsu, Kanagawa (JP); Yoshiko Saito, Kanagawa (JP); Takashi Aramaki, Osaka (JP)

(73) Assignee: PANASONIC CORPORATION, Osaka (JP)

(21) Appl. No.: 12/999,480

(22) PCT Filed: Jun. 10, 2009
(86) PCT No.: PCT/JP2009/002628

§ 371 Date: Dec. 16, 2010

(30) Foreign Application Priority Data
Jun. 19, 2008 (JP) P2008-160754

(51) Int. Cl. H04B 7/14

(52) U.S. Cl. 455/7

(57) ABSTRACT

Disclosed is a radio communication device capable of using a resource in which the signal cannot be received by all relay stations participating in cooperative relay for a cooperative relay. A signal-receivable frequency resource determination unit 104 determines a signal-receivable resource that can receive signals from the resources used for the cooperative relay on the basis of scheduling information, and a transmission selection unit 110 selects a radio communication relay method on the basis of a determination result of the determination unit.

### TECHNICAL FIELD

The present invention relates to a radio communication device.

### BACKGROUND ART

In recent years, in cellular mobile communication systems, with the combination of various kinds of information into multimedia, a large amount of data, such as voice data, still image data, and moving image data, is generally transmitted. A technique for achieving a high transmission rate using a high-frequency radio band has been actively studied in order to transmit a large amount of data.

When the high-frequency radio band is used, it is possible to expect a high transmission rate in a short distance. However, as the distance increases, attenuation due to a transmission distance increases. When a mobile communication system using the high-frequency radio band is operated in practice, the coverage of a radio communication base station device (hereinafter, simply referred to as a base station) is reduced. Therefore, it is necessary to set a large number of base stations. Since the setting cost of the base stations is great, there is a strong demand for a technique capable of providing a communication service using the high-frequency radio band while preventing an increase in the number of base stations.

In order to meet the demand, a relay transmission technique has been studied in which a radio communication relay station device (hereinafter, simply referred to as a relay station) is provided between a base station and a radio communication mobile station device (hereinafter, simply referred to as a mobile station) in order to expand the coverage of each base station and the communication between the base station and the mobile station is performed through the relay station. When the relay transmission technique is used, a terminal that cannot directly communicate with the base station can communicate with the base station through the relay station.

One of the relay techniques is cooperative relay in which a plurality of relay stations relay signals in cooperation with each other.

FIG. 22 schematically illustrates a cooperative relay system that cooperatively relays the communication between the mobile station and the base station. In FIG. 22, a mobile station 804 transmits a relay signal to a plurality of relay stations 800A, 800B, and 800C, and a base station 803 receives the relay signal through the plurality of relay stations 800A, 800B, and 800C. Therefore, it is possible to obtain a diversity effect. In FIG. 22, the mobile station 804 functions as a transmission station and the base station 803 functions as a reception station.

The cooperative relay is also called collaborative relay and corporative relay.

In order to improve the diversity effect, a method has been proposed in which the relay stations that perform cooperative relay adjust transmission power or phase on the basis of a channel quality between the mobile station and the relay station and a channel quality between the relay station and the reception station (see Patent Literature 1). However, in the cooperative relay system disclosed in Patent Literature 1, it is premised that all of the relay stations participating in cooperative relay can receive the same resource. Therefore, there is a problem in that it is complicated to schedule the resources that can be received by all of the relay stations.

In addition, in the cooperative relay system, in some resources allocated to transmission, the relay station is affected by coupling loop interference and the relay station cannot receive signals in the resources.

Next, cooperative relay when the relay station is affected by coupling loop interference will be described with reference to FIG. 23. FIG. 23 schematically illustrates an aspect of the cooperative relay when the relay station is affected by coupling loop interference. In FIG. 23, a signal from a mobile station 904 is relayed to a base station 903 by a relay station 900A.

A frequency F3 is allocated as a transmission resource to the relay station 900A and frequencies F1 and F2 are allocated as a transmission resource to a mobile station 904. In this case, the signal of the frequency F3 transmitted by the relay station 900A also reaches a receiving antenna of the relay station 900A. As a result, the relay station 900A receives the signals of the frequencies F1, F2, and F3 through the receiving antenna. When the frequencies F2 and F3 are adjacent to each other, the signal of the frequency F3 interferes with the signal of the frequency F2. Since the signal of the frequency F3 is transmitted from the relay station 900A, reception power increases, and interference power also increases. Therefore, it is difficult for the relay station 900A to receive a resource (hereinafter, referred to as an adjacent resource) adjacent to the resource used for transmission.

As described above, the frequency range in which it is difficult to receive an adjacent resource depends on, for example, a device, such as a filter, and an interference removing function of the relay station. In addition, as described above, the resources in which the signals cannot be received vary depending on the transmission resources allocated to each relay station. Therefore, it is necessary to schedule the resources used for cooperative relay so that all relay stations participating in cooperative relay can receive signals in the resources. When the resources are not scheduled so that all of the relay stations can receive signals in the resources, there is a possibility that the received signal cannot be decoded.

### Citation List

### Patent Literature

Patent Literature 1: JP-T-2007-500482

### SUMMARY OF INVENTION

### Technical Problem

In the cooperative relay system according to the related art, it is premised that all of the relay stations participating in cooperative relay can receive signals in the same resource. Therefore, there is a problem in that it is difficult to use the resources in which the signal can be received by all of the relay stations for cooperative relay.

In order to solve the above-mentioned problems, an object of the invention is to provide a radio communication device capable of using resources in which the signals cannot be received by all relay stations participating in cooperative relay for the cooperative relay.

### Solution to Problem

A radio communication device that relays radio communication according to the invention includes: a determination unit that determines a signal-receivable resource indicating a resource in which a signal can be received, from resources used for cooperative relay on the basis of scheduling information; and a selection unit that selects a method of relaying the radio communication on the basis of a determination result of the determination unit.

According to the above-mentioned structure, it is possible to use the resources in which the signals cannot be received by all of the relay stations participating in cooperative relay for the cooperative relay. In addition, the scheduling of the base station is simplified.

In the radio communication device, the determination unit determines whether the signal in the signal-receivable resource can be decoded by the radio communication device. Further, the selection unit selects a decode-and-forward relay as the radio communication relay method when the signal in the signal-receivable resource can be decoded by the radio communication device and selects an amplify-and-forward relay as the radio communication relay method when the signal in the signal-receivable resource cannot be decoded by the radio communication device.

According to the above-mentioned structure, it is possible to transmit the resources in which the signals cannot be received using amplify-and-forward relay and thus obtain a diversity effect.

Further, in the radio communication device, on the basis of relay station information for specifying another radio communication device that relays the radio communication, in addition to the scheduling information, the determination unit determines whether the other specified radio communication device can decode the signal in the signal-receivable resource. The selection unit selects, as the radio communication relay method, a method of relaying the radio communication with the same MCS used for a resource, which the other radio communication device that cannot decode the signal in the signal-receivable resource uses for the cooperative relay, on the basis of a determination result of the determination unit.

According to the above-mentioned structure, in the resources that are relayed by the relay station that cannot perform decoding, it is possible to transmit an amplify-and-forward relay signal and a decode-and-forward relay signal with the same resource.

Further, a relay signal contained in a resource in which a signal is not transmitted by the other radio communication device performing an amplify-and-forward relay among the signal-receivable resources is relayed with an MCS converted for relay transmission of the radio communication.

According to the above-mentioned structure, a decode-and-forward relay signal is set to an MCS suitable for a channel quality between the relay station and the base station.

A radio communication device that communicates with another radio communication device using a cooperative relay between relay stations according to the invention allocates a transmission signal that is to be transmitted to the other radio communication device through the relay stations performing the cooperative relay to each of the relay stations so that all of the relay stations can decode the transmission signal.

According to the above-mentioned structure, the signal received by the relay station can be decoded all the time and be cooperatively relayed by a decode-and-forward relay method. Therefore, a diversity effect is improved.

In the radio communication device according to claim 5, resources for the transmission signal allocated to a plurality of other radio communication devices in order to perform the cooperative relay are divided so that all of the relay stations can decode the transmission signal.

According to the above-mentioned structure, it is possible to reduce the amount of signaling.

Further, the radio communication device transmits a systematic bit using a resource that can be commonly received by each of the relay stations among the resources for the transmission signal allocated to each of the relay stations in order to perform the cooperative relay, and transmits a parity bit using a resource that cannot be commonly received by each of the relay stations.

According to the above-mentioned structure, since each relay station can receive the systematic bit and the parity bit, an error correction effect is improved.

The radio communication device allocates, when signals in the resources for the transmission signal allocated to each of the relay stations in order to perform the cooperative relay cannot be commonly received by each of the relay stations, the transmission signal to each of the relay stations so that the transmission signal can be decoded using one of the resources.

According to the above-mentioned structure, the relay station having a small amount of signal-receivable resources can participate in cooperative relay.

### Advantageous Effects of Invention

According to the radio communication device of the invention, it is possible to use the resources in which the signals cannot be received by all relay stations participating in cooperative relay for the cooperative relay.

### BRIEF DESCRIPTION OF DRAWINGS

FIG. 1 schematically illustrates a cooperative relay system that cooperatively relays communication between a mobile station 4 and a base station 3 in a first embodiment.

FIG. 2 illustrates an example of a frequency resource in which the signal can be received by a relay station 100 in the first embodiment.

FIG. 3 is a block diagram illustrating the structure of the relay station 100 according to the first embodiment.

FIG. 4 is a flowchart illustrating a method of determining a signal-receivable frequency resource in the first embodiment.

FIG. 5 schematically illustrates a cooperative relay system that cooperatively relays communication between a mobile station 4 and a base station 3 in a second embodiment.

FIG. 6 illustrates a regeneration method of relay stations and the frequency resources thereof in the second embodiment.

FIG. 7 illustrates a relay method when the reception frequency and the transmission frequency of each relay station are equal to each other in the second embodiment.

FIG. 8 illustrates a relay method when the reception frequency and the transmission frequency of each relay station are different from each other in the second embodiment.

FIG. 9 is a block diagram illustrating a relay station 200 according to the second embodiment.

FIG. 10 is a flowchart illustrating the operation of a transmission resource allocation unit 210 according to the second embodiment.

FIG. 11 schematically illustrates a cooperative relay system that cooperatively relays communication between a mobile station 4 and a base station 3 in a third embodiment.

FIG. 12 illustrates an example of the division of resources based on an instruction method A according to the third embodiment.

FIG. 13 is a block diagram illustrating a relay station according to the third embodiment.

FIG. 14 is a block diagram illustrating a mobile station according to the third embodiment.

FIG. 15 illustrates an example of the frequencies that can be received by each relay station in the third embodiment.

FIG. 16 illustrates an example of the division of the frequency resources in the mobile station in the third embodiment.

FIG. 17 illustrates an example of the division of the frequency resources in the mobile station when there is a plurality of frequencies that can be commonly received by a plurality of relay stations.

FIG. 18 illustrates an example of the frequency that can be received by each relay station when there is no frequencies that can be commonly received by a plurality of relay stations.

FIG. 19 illustrates an example of the division of the frequency resources in the mobile station 4 when there is no frequencies that can be commonly received by a plurality of relay stations.

FIG. 20 illustrates an example of the transmission of signals by the relay station when there is no frequencies that can be commonly received by a plurality of relay stations.

FIG. 21 is a block diagram illustrating a relay station based on an instruction method B according to the third embodiment.

FIG. 22 schematically illustrates a cooperative relay system that cooperatively relays communication between a mobile station and a base station.

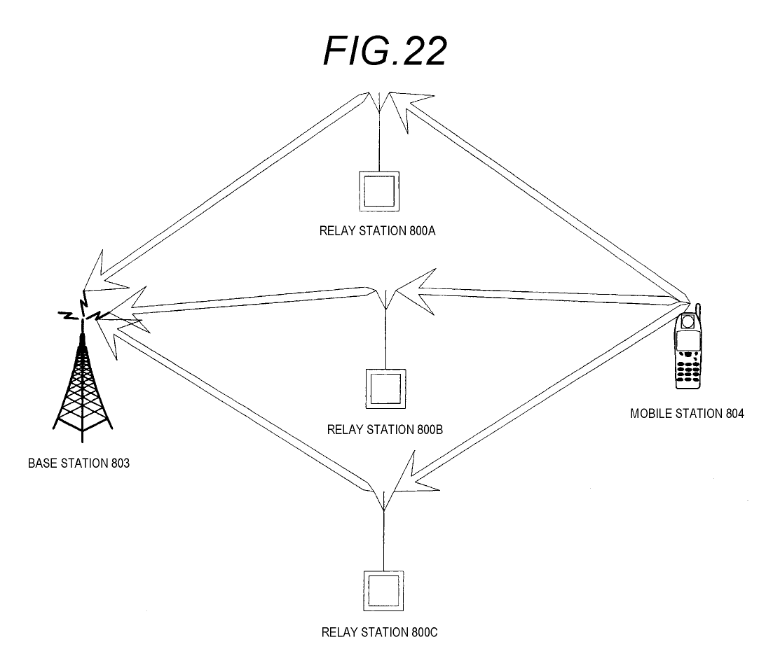

FIG. 23 illustrates an aspect of cooperative relay when the relay station is affected by coupling loop interference.

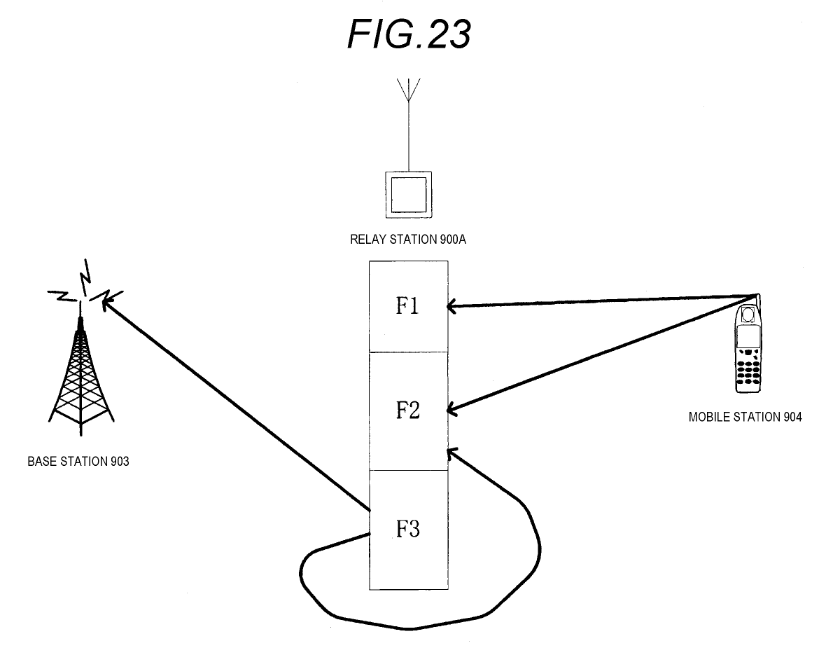

### DESCRIPTION OF EMBODIMENTS

Hereinafter, exemplary embodiments of the invention will be described with reference to the accompanying drawings.

### First Embodiment

In a first embodiment, a relay station determines whether to receive signals in a plurality of resources used for cooperative relay and selects a relay method on the basis of its determination result. When the relay station can receive signals in a combination of resources that can be decoded, it selects decode-and-forward relay as the relay method. When the relay station can receive only signals in the resources that cannot be decoded, it performs amplify-and-forward relay as the relay method. Therefore, it is possible to use the resources in which the signals cannot be received by all of the relay stations participating in cooperative relay for the cooperative relay and reduce the scheduling load of a base station.

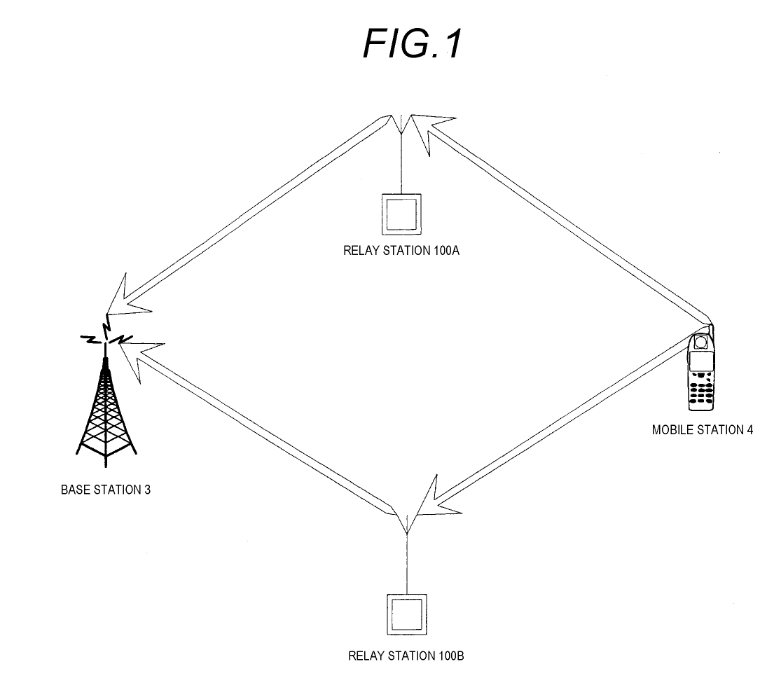

The operation of the first embodiment when relay stations 100A and 100B participate in cooperative relay will be described with reference to FIG. 1. FIG. 1 schematically illustrates a cooperative relay system according to the first embodiment in which relay stations cooperatively relay communication between a mobile station 4 and a base station 3.

In the cooperative relay system shown in FIG. 1, the relay stations 100A and 100B cooperatively relay the communication between the mobile station 4 and the base station 3. The relay stations 100A and 100B receive signals from the mobile station 4 and relay the signals to the base station 3.

It is assumed that the mobile station 4 transmits signals using frequency resources f4, f8, f12, and f16. In addition, it is assumed that four frequency resources adjacent to a frequency resource used for transmission cannot be used as frequency resources for reception.

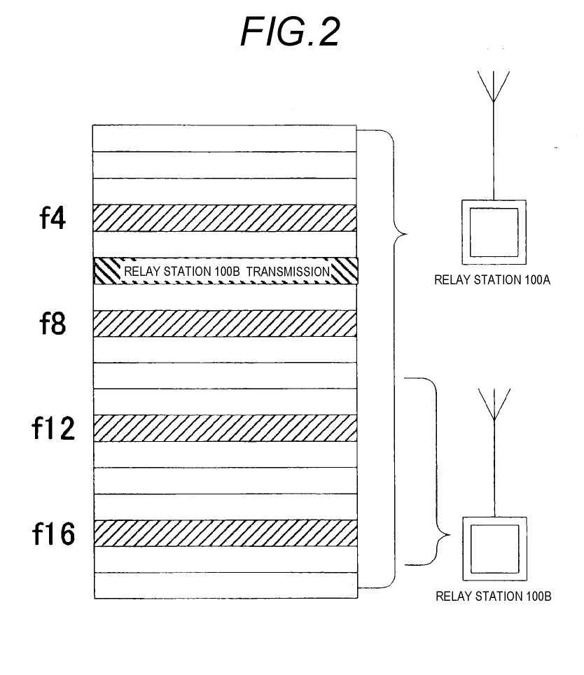

FIG. 2 shows an example of the frequency resource in which the signal can be received by the relay stations 100A and 100B in the first embodiment. The relay station 100A can receive signals in all of the frequency resources f4, f8, f12, and f16 transmitted by the mobile station 4. As shown in FIG. 2, since the relay station 100A can receive signals in all of the frequency resources f4, f8, f12, and f16 transmitted by the mobile station 4, the relay station 100A receives the frequency resources f4, f8, f12, and f16 from the mobile station 4 and relays the received frequency resources to the base station 3 in a decode-and-forward manner.

The decode-and-forward relay means a method that performs error correction decoding on a received signal, performs error correction encoding on the error-correction-decoded signal, and forwards the error-correction-encoded signal. When the decode-and-forward relay is performed, the relay station can correct the error of the signal. Therefore, it is possible to improve the reception quality of signals in the base station.

As shown in FIG. 2, the relay station 100B uses the frequency f6 as a frequency resource for transmission. In the first embodiment, since four frequency resources adjacent to the frequency resource used for transmission cannot be used as frequency resources for reception, the relay station 100B cannot receive the frequency resources f4 and f8 included in the four resources adjacent to the frequency resource f6 for transmission from the mobile station 4. That is, the relay station 100B does not receive the frequency resources f4 and f8 from the mobile station 4, but receives the frequency resources f12 and f16 from the mobile station 4. Since the relay station 100B can receive only some of the signals transmitted from the mobile station 4, the relay station 100B relays the other receivable signals to the base station 3 in an amplify-and-forward manner.

The amplify-and-forward relay means a method that only amplifies the received signal and forwards the amplified signal. Since the received signal is only amplified, it is difficult to remove noise added between the mobile station and the relay station from the received signal. Therefore, in the amplify-and-forward relay, the reception quality of signals in the base station is lower than that in the decode-and-forward relay.

As described above, in the first embodiment, the relay station 100B relays signals received from the mobile station 4 using the frequency resources f12 and f16 between the mobile station 4 and the relay station 100B, unlike the frequency resources f4, f8, f12, and f16 used between the mobile station 4 and the relay station 100A. Therefore, different amounts of noise are added. Similarly, since a transmission path between the relay station 100A and the base station 3 is different from that between the relay station 100B and the base station 3, different amounts of noise are added. Therefore, even when the relay station 100B receives a signal including noise from the mobile station 4, it is possible to improve the reception quality of signals in the base station 3 using the amplify-and-forward relay, as compared to the structure in which the transmission of signals from the relay station to the base station stops.

When the relay station 100A cannot decode the received signal due to a reception error, the relay station 100A may relay the received signal in an amplify-and-forward manner, similar to the relay station 100B.

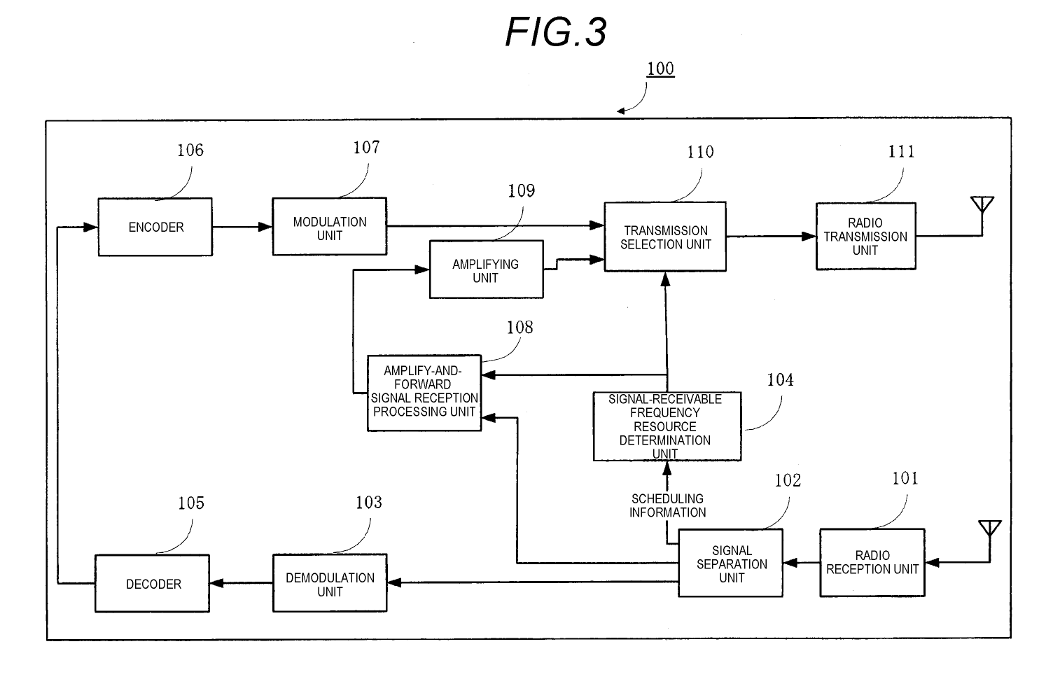

Next, the structure of a relay station 100 according to the first embodiment will be described with reference to FIG. 3. FIG. 3 is a block diagram illustrating the structure of the relay station 100 according to the first embodiment. The relay station 100 includes a radio reception unit 101, a signal separation unit 102, a demodulation unit 103, a signal-receivable frequency resource determination unit 104, a decoder 105, an encoder 106, a modulation unit 107, an amplify-and-forward signal reception processing unit 108, an amplifying unit 109, a transmission selection unit 110, and a radio transmission unit 111.

The radio reception unit 101 receives a signal from the mobile station or the relay station through an antenna, performs radio processing, such as down-conversion, on the received signal, and outputs the processed signal to the signal separation unit 102.

The signal separation unit 102 separates the signal received from the mobile station or the relay station into a relay signal and scheduling information. Then, the signal separation unit 102 inputs the relay signal to the amplify-and-forward signal reception processing unit 108 and the demodulation unit 103.

The scheduling information is frequency allocation information that is used by the mobile station to transmit signals to the base station. The use of the frequency allocation information by the mobile station is allowed by the base station.

The demodulation unit 103 demodulates the relay signal and outputs the demodulated relay signal to the decoder 105.

The decoder 105 decodes the relay signal and outputs the decoded relay signal to the encoder 106.

The encoder 106 encodes the relay signal and outputs the encoded relay signal to the modulation unit 107.

The modulation unit 107 modulates the relay signal and outputs the modulated relay signal to the transmission selection unit 110.

The signal-receivable frequency resource determination unit 104 determines a frequency resource in which the signal can be received by the relay station on the basis of the scheduling information from the mobile station to the relay station and the scheduling information from the relay station to the base station, and outputs the determination result to the amplify-and-forward signal reception processing unit 108 and the transmission selection unit 110.

The amplify-and-forward signal reception processing unit 108 separates the received signal for each frequency resource, selects a signal-receivable frequency resource from the determination result of the signal-receivable resource determination unit, and outputs the selected signal-receivable frequency resource to the amplifying unit 109.

The amplifying unit 109 amplifies the signal of the signal-receivable frequency resource and outputs the amplified signal to the transmission selection unit 110.

The transmission selection unit 110 determines whether a decodable signal in a frequency resource can be received on the basis of the determination result of the frequency resource determination unit 104. When it is determined that the decodable signal in the frequency resource can be received, the transmission selection unit 110 selects an input from the modulation unit 107. When it is determined that the decodable frequency resource cannot be received, the transmission selection unit 110 selects an input from the amplifying unit 109 and outputs the selected input to the radio transmission unit 111.

The radio transmission unit 111 performs radio processing, such as up-conversion, on the modulated signal and relays and transmits the processed signal from an antenna to the base station.

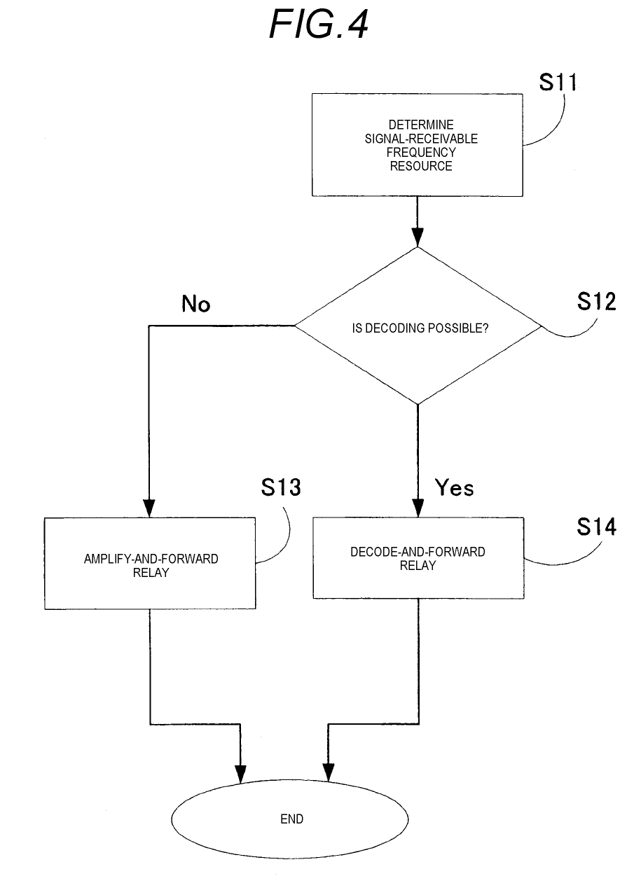

Next, a method of determining the frequency resource in which the signal can be received by the relay station 100 will be described. FIG. 4 is a flowchart illustrating the method of determining a signal-receivable frequency resource according to the first embodiment. The signal-receivable frequency resource determination unit 104 and the transmission selection unit 110 determine the signal-receivable frequency resource.

First, the signal-receivable frequency resource determination unit 104 determines a frequency resource in which the signal can be received by the relay station 100 and decides a signal-receivable frequency resource (hereinafter, referred to as a signal-receivable resource) from the frequency resources that are allocated for transmission and the frequency resources that are allocated for reception (Step S11). Then, the signal-receivable frequency resource determination unit 104 determines whether the own station (relay station 100) including the signal-receivable frequency resource determination unit 104 can decode the signal-receivable resource (Step S12). Then, when all of the frequency resources transmitted from the mobile station 4 to the relay station 100 can be received, the signal-receivable frequency resource determination unit 104 determines that decoding is possible. When at least some of the frequency resources cannot be received, the signal-receivable frequency resource determination unit 104 determines that decoding is impossible. When it is determined that decoding is impossible, only the signals received with the signal-receivable resources are relayed in the amplify-and-forward manner (Step S13). On the other hand, when it is determined that the decoding is possible, decode-and-forward relay that demodulates/decodes the relay signal and then encodes/modulates the demodulated/decoded relay signal is performed (Step S14).

As described above, in the first embodiment, it is determined whether the relay station can receive signals in a plurality of resources used for cooperative relay and the relay method is selected on the basis of the determination result.

When the relay station can receive signals in a combination of signal-receivable resources, it performs decode-and-forward relay. On the other hand, when the relay station can receive only signals in the resources that cannot be decoded, it performs amplify-and-forward relay. Therefore, it is possible to use the resources, which can be used by only some of the relay stations participating in cooperative relay, for the cooperative relay and reduce the scheduling load of the base station.

The unit of the frequency resource may be an RB (Resource Block), an OFDM sub-carrier, a frequency band, or a system bandwidth. In addition, the unit of the frequency resource may be a group consisting of them.

The base station may notify each relay station that how far the frequency resource can be received by the relay station from the frequency resources allocated for transmission, or alternatively, it may be uniformly defined as a system.

### Second Embodiment

In a second embodiment, a relay station determines whether there is a relay station that cannot perform decoding among the relay stations that perform cooperative relay, on the basis of the frequency resources allocated to other relay stations. Transmission resources allocated to each relay station are compared with reception resources received by the relay station to determine whether there is a relay station that cannot perform decoding.

When there is a relay station that cannot perform decoding, the relay station that can perform decoding relays the frequency resources relayed by the relay station that cannot perform decoding, using the MCS (Modulation and Coding Scheme) used by the relay station that cannot perform decoding to transmit signals, that is, the MCS used by the relay station to receive the relay signal from the mobile station.

According to the configuration, the relay station that performs decode-and-forward relay can also transmit signals with the frequency resources that are used to relay and transmit signals in the amplify-and-forward manner. Therefore, a diversity effect is improved.

In addition, it is possible to relay the frequency resources relayed by only the relay station that can perform decoding with changing the MCS.

The resources in which the signals cannot be received by all of the relay stations participating in cooperative relay can be used for cooperative relay, and it is possible to reduce the scheduling load of the base station.

In the second embodiment, for example, a case in which relay stations 200A, 200B, and 200C participate in cooperative relay will be described.

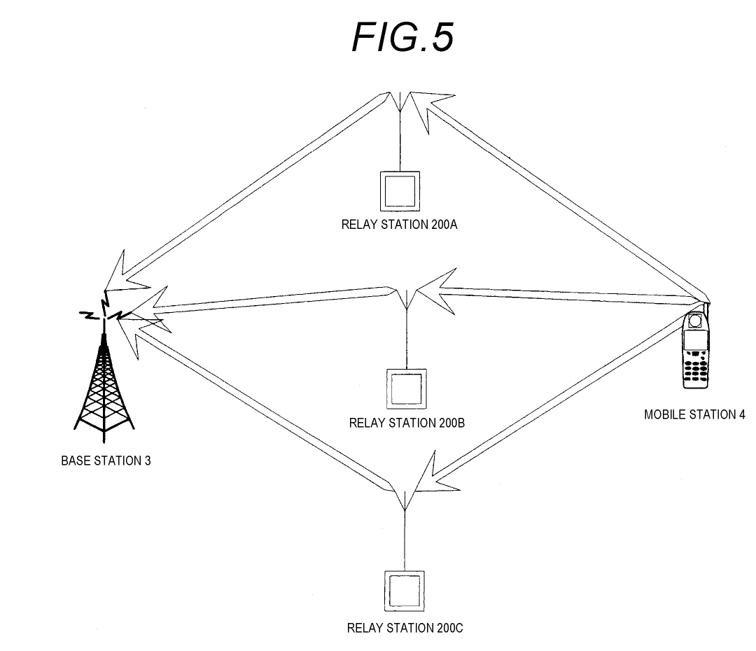

FIG. 5 schematically illustrates a cooperative relay system that cooperatively relays communication between the mobile station 4 and the base station 3 in the second embodiment. In the cooperative relay system shown in FIG. 5, the relay stations 200A, 200B, and 200C cooperatively relay the communication between the mobile station 4 and the base station 3. The relay stations 200A, 200B, and 200C receive signals from the mobile station 4 and relay the received signals to the base station 3. The mobile station 4 transmits signals using frequency resources f4, f8, f12, and f16, similar to the first embodiment.

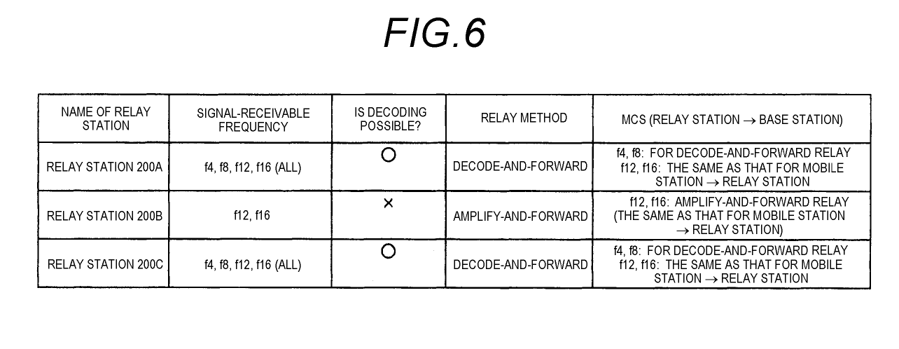

FIG. 6 shows a regeneration method of each relay station and the frequency resources thereof. It is assumed that four resources adjacent to the frequency resource used for transmission cannot be used as frequency resources for reception.

As shown in FIG. 6, the relay stations 200A and 200C can receive signals in all of the frequency resources f4, f8, f12, and f16 transmitted from the mobile station 4. Therefore, the relay stations 200A and 200C receive the frequency resources f4, f8, f12, and f16 from the mobile station 4 and relay the received frequency resources in a decode-and-forward manner.

Since the relay station 200B uses a frequency f6 as a frequency resource for transmission, similar to the first embodiment, it cannot receive the frequency resources f4 and f8 included in four resources adjacent to the frequency resource f6 for transmission. Therefore, the relay station 200B receives only the frequency resources f12 and f16 and relays the receivable signals in an amplify-and-forward manner.

Next, a decode-and-forward relay method of the relay stations 200A and 200C and the relay station 200B will be described.

First, the relay stations 200A and 200C determine that the relay station 200B participating in cooperative relay can relay only the frequency resources f12 and f16 on the basis of scheduling information between the relay station 200B and the base station transmitted from the base station and relay station information for specifying the relay stations participating in cooperative relay.

The relay stations 200A and 200C relay the signals received using the frequency resources f12 and f16 with the same modulation multi-value number/symbol arrangement as that of the received signals. When the signals are relayed with the same modulation multi-value number/symbol arrangement as that of the received signals, the modulation multi-value number/symbol arrangement is the same as the modulation multi-value number/symbol arrangement of the signals transmitted by the relay station that performs amplify-and-forward relay. The term “symbols having the same arrangement” indicates that, when the signals that are encoded with the same error correction code and at the same encoding ratio are subjected to the same interleaving and padding and then transmitted as symbols, the same symbol is transmitted substantially at the same time and the same frequency.

The relay stations 200A and 200C change the modulation multi-value number for decode-and-forward relay and the symbol arrangement of the signals received with the frequency resources f4 and f8 and relay the signals. In this case, the encoding ratio of the error correction code for the signals received with the frequency resources f4 and f8 may be changed. The error correction code and encoding ratio used may be predetermined for decode-and-forward relay or it may be notified by the base station.

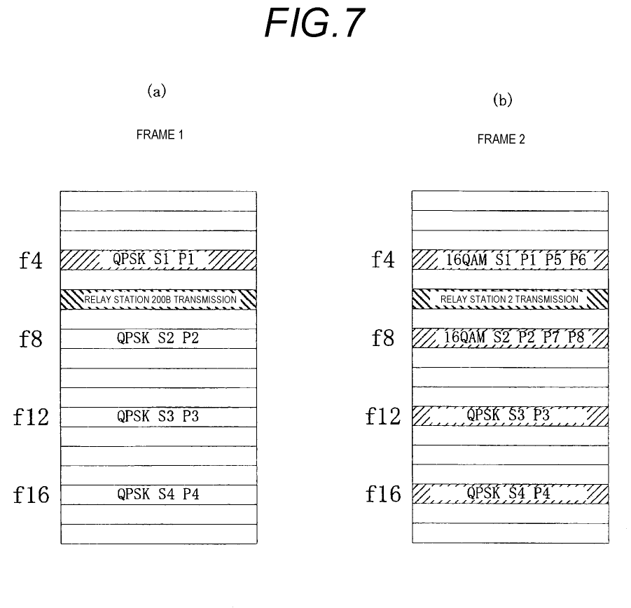

In the second embodiment, the relay method of each relay station when a reception frequency and a transmission frequency are equal to each other will be described with reference to FIG. 7. FIG. 7 shows the relay method of each relay station when the reception frequency and the transmission frequency are equal to each other in the second embodiment.

As described above, the mobile station 4 transmits signals using the frequency resources f4, f8, f12, and f16, similar to the first embodiment. It is assumed that four resources adjacent to the frequency resource used for transmission cannot be used as frequency resources for reception. Therefore, the relay stations 200A and 200C can receive signals in all of the frequency resources f4, f8, f12, and f16 that are used for transmission by the mobile station 4. Since the relay station 200B uses the frequency f6 as a frequency resource for transmission, it can receive only the frequency resources f12 and f16.

In FIG. 7, (a) shows a frame 1 indicating a modulation method in each frequency resource when the mobile station transmits signals to each relay station and the kind of signals allocated to each frequency resource, when the reception frequency and the transmission frequency of each relay station are equal to each other. It is assumed that the mobile station allocates QPSK as the modulation multi-value number to the relay station.

The mobile station 4 transmits QPSK-modulated signals using the frequency resources f4, f8, f12, and f16.

The mobile station 4 transmits a systematic bit 51 and a parity bit P1 using the frequency resource f4. The mobile station 4 transmits a systematic bit S2 and a parity bit P2 using the frequency resource f8. The mobile station 4 transmits a systematic bit S3 and a parity bit P3 using the frequency resource f12. The mobile station 4 transmits a systematic bit S4 and a parity bit P4 using the frequency resource f16. A systematic bit is represented by Sn (n=1, 2, . . . , n: n is a natural number), and a parity bit is represented by Pn (n=1, 2, . . . , n: n is a natural number).

In FIG. 7, (b) shows a frame 2 indicating a modulation method in the frequency resources f4, f8, f12, and f16 when each relay station transmits signals to the base station and the kind of signals allocated to each frequency resource, when the reception frequency and the transmission frequency are equal to each other in each relay station. It is assumed that the relay station allocates 16 QAM as the modulation multi-value number to the base station.

The relay station 200B relays signals S3 and P3 and signals S4 and P4, which are received using the frequency resources f12 and f16 for transmission, at the same frequency and with the same modulation method, QPSK, in an amplify-and-forward manner.

The relay stations 200A and 200C perform demodulation and error correction decoding on the signals received from the mobile station.

After demodulating the signals, the relay stations 200A and 200C perform decode-and-forward relay on the signals S3 and P3 and the signals S4 and P4, which are received with the frequency resources f12 and f16, at the same frequency at that of the relay station 200B and with the same modulation method QPSK as that of the relay station 200B in order to adapt the signals for the modulation method (QPSK) of the relay station 200B.

The relay stations 200A and 200C increase the parity bits of the signals received with the frequency resources f4 and f8 since the modulation multi-value number from each of the relay stations 200A and 200C to the base station 4 is 16 QAM. Then, the relay stations 200A and 200C modulate S1, P1, P5, and P6 with 16 QAM in the frequency resource f4 and relay the modulated signals to the base station 3. The relay stations 200A and 200C modulate S2, P2, P7, and P8 with 16 QAM in the frequency resource f8 and relay the modulated signals to the base station 3.

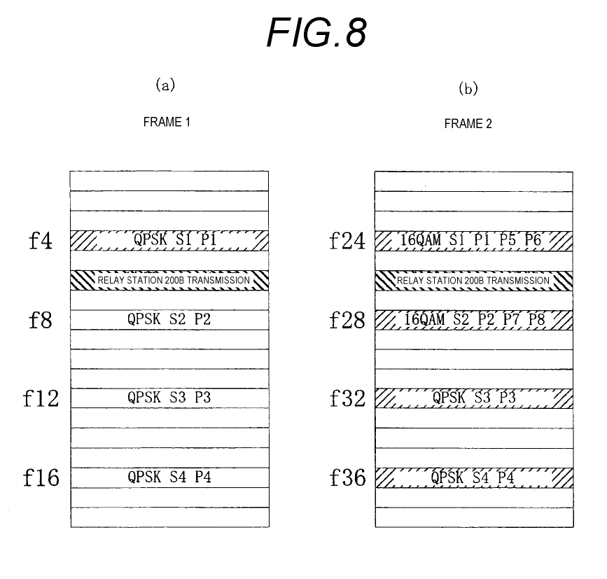

In the second embodiment, a relay method when the reception frequency and the transmission frequency of each relay station are different from each other will be described with reference to FIG. 8. FIG. 8 illustrates the relay method when the reception frequency and the transmission frequency of each relay station are different from each other in the second embodiment.

Similar to (a) in FIG. 7, in FIG. 8, (a) shows a frame 1 indicating a modulation method in each frequency resource when the mobile station transmits signals to each relay station and the kind of signals allocated to each frequency resource, when the reception frequency and the transmission frequency of each relay station are different from each other. It is assumed that the mobile station allocates QPSK as the modulation multi-value number to the relay station.

The mobile station 4 transmits QPSK-modulated signals using the frequency resources f4, f8, f12, and f16 in the frame 1. The mobile station 4 transmits S1 and P1 using the frequency resource f4. The mobile station 4 transmits S2 and P2 using the frequency resource f8. The mobile station 4 transmits S3 and P3 using the frequency resource f12. The mobile station 4 transmits S4 and P4 using the frequency resource f16.

In FIG. 8, (b) shows a frame 2 indicating a modulation method in frequency resources f24, f28, f32, and f36 when each relay station transmits signals to the base station and the kind of signals allocated to each frequency resource, when the reception frequency and the transmission frequency of each relay station are different from each other. It is assumed that the relay station allocates 16 QAM as the modulation multi-value number to the base station. Unlike (b) in FIG. 7, the transmission frequencies of each relay station are f24, f28, f32, and f36.

The relay station 200B relays S3 and P3, and S4 and P4, which are respectively received with the frequency resources f12 and f16 for transmission, at the transmission frequencies f32 and f36 using the modulation method QPSK in an amplify-and-forward manner.

The relay stations 200A and 200C perform demodulation and error correction decoding on the signals received from the mobile station. After demodulating the signals, for the signals S3, P3, S4, and P4 received with the frequency resources f12 and f16, the relay stations 200A and 200C perform decode-and-forward relay on the signals S3, P3, S4, and P4, which are received with the frequency resources f12 and f16, at the same frequencies f32 and f36 as those of the relay station 200B using the same modulation method QPSK as that of the relay station 200B in order to adapt the signals for the modulation method QPSK of the relay station 200B.

The relay stations 200A and 200C increase the parity bits of the signals received with the frequency resources f4 and f8 since the modulation multi-value number from each of the relay stations 200A and 200C to the base station 4 is 16 QAM. Then, the relay stations 200A and 200C modulate S1i, P1, P5, and P6 with 16 QAM in the frequency resource f24 and relay the modulated signals to the base station 3. The relay stations 200A and 200C modulate S2, P2, P7, and P8 with 16 QAM in the frequency resource f28 and relay the modulated signals to the base station 3.

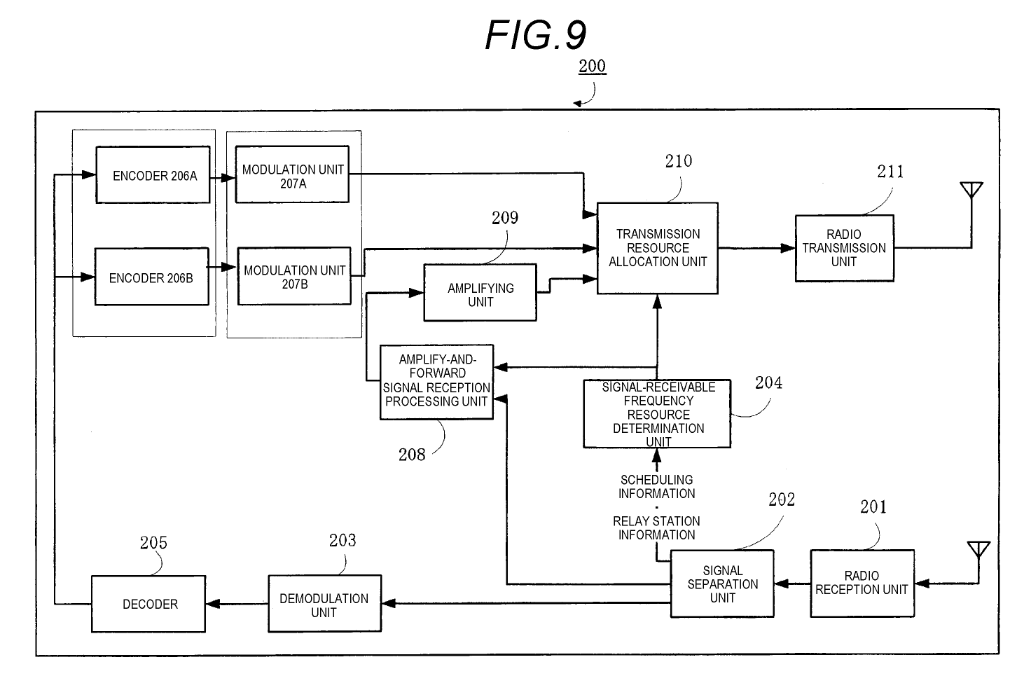

FIG. 9 is a block diagram illustrating the relay station 200 according to the second embodiment.

The relay station 200 includes a radio reception unit 201, a signal separation unit 202, a demodulation unit 203, a signal-receivable frequency resource determination unit 204, a decoder 205, encoders 206A and 206B, modulation units 207A and 207B, an amplify-and-forward signal reception processing unit 208, an amplifying unit 209, a transmission resource allocation unit 210, and a radio transmission unit 211.

The radio reception unit 201 receives a signal from the mobile station or the relay station through an antenna, performs radio processing, such as down-conversion, on the received signal, and outputs the processed signal to the signal separation unit 202.

The signal separation unit 202 separates the signal received from the radio reception unit 201 into scheduling information, relay station information, and a received signal. Then, the signal separation unit 102 outputs the scheduling information and the relay station information to the signal-receivable frequency resource determination unit 204, and outputs the received signal to the amplify-and-forward signal reception processing unit 208 and the demodulation unit 203.

The signal-receivable frequency resource determination unit 204 determines a signal-receivable frequency on the basis of the scheduling information and outputs the determination result to the amplify-and-forward signal reception processing unit 208 and the transmission resource allocation unit 210.

In addition, the signal-receivable frequency resource determination unit 204 searches for the relay station that performs amplify-and-forward relay among the relay stations participating in cooperative relay on the basis of the information of the relay stations participating in cooperative relay, and notifies the frequency transmitted by the relay station that performs amplify-and-forward relay to the transmission resource allocation unit 210.

The decoder 205 outputs a decoded signal to the encoder 206A and the encoder 206B.

The encoder 206A performs the same encoding as that for the received signal and outputs the encoded signal to the modulation unit 207A.

The modulation unit 207A performs modulation with the same modulation multi-value number as that of the received signal and outputs the modulated signal to the transmission resource allocation unit 210.

The encoder 206B performs encoding with the code allocated from the relay station to the base station and outputs the encoded signal to the modulation unit 207B.

The modulation unit 207B performs modulation with the modulation multi-value number allocated from the relay station to the base station and outputs the modulated signal to the transmission resource allocation unit 210.

When the signal-receivable resource is limited and amplify-and-forward relay is performed, the transmission resource allocation unit 210 allocates the output from the amplifying unit 209 to the transmission resource. When the signal-receivable resource is not limited and can be decoded, the transmission resource allocation unit 210 determines whether there is a relay station that performs amplify-and-forward relay among other relay stations on the basis of the scheduling information and the relay station information, allocates the output of the modulation unit 207A to the frequency resources that are relayed by other relay stations in an amplify-and-forward manner, and outputs the frequency resource to the radio transmission unit 211. In addition, the transmission resource allocation unit 210 allocates the output of the modulation unit 207B to the frequency resources that are relayed by all of the relay stations in a decode-and-forward manner and outputs the frequency resource to the radio transmission unit 211.

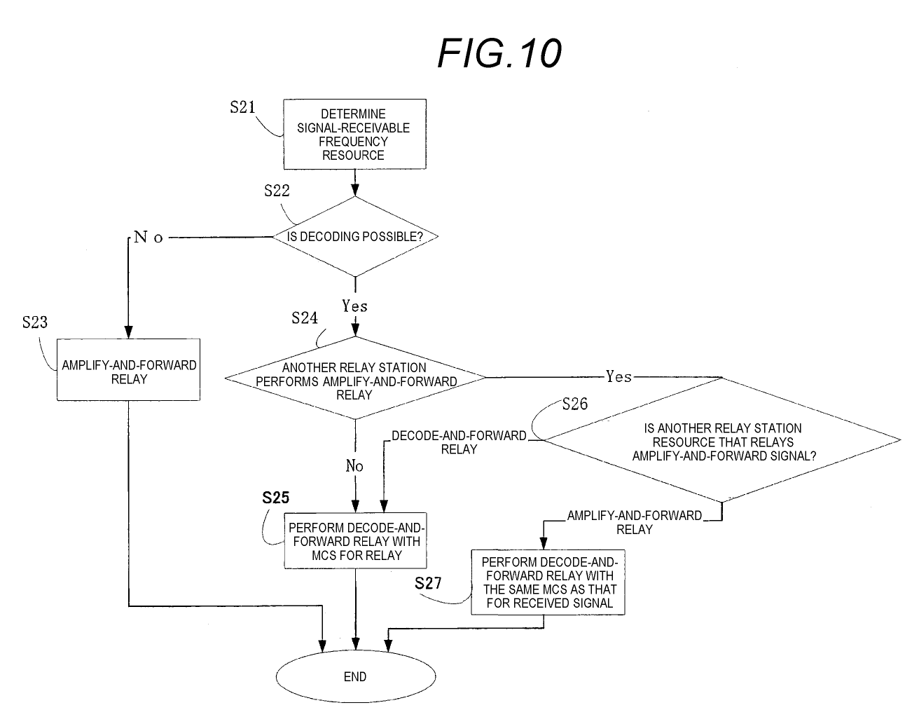

Next, the operation of the transmission resource allocation unit 210 according to this embodiment will be described with reference to FIG. 10.

FIG. 10 is a flowchart illustrating the operation of the transmission resource allocation unit 210 according to the second embodiment.

First, since processes in steps S21 and S23 are similar to those in steps S11 to S13, respectively, the detailed explanation thereof is omitted here. Next, the transmission resource allocation unit 210 determines whether there is a relay station that performs amplify-and-forward relay among other relay stations on the basis of the scheduling information and the relay station information That is, the transmission resource allocation unit 210 determines whether other relay stations participating in cooperative relay perform decode-and-forward relay or amplify-and-forward relay (Step S24). In the case where at least any one of the other relay stations perform the decode-and-forward relay, the decode-and-forward relay is performed with an MCS for relay (Step S25). In the case where at least any one of the other relay stations performs the amplify-and-forward relay, the transmission resource allocation unit 210 determines whether the resource is relayed by other relay stations in an amplify-and-forward manner (Step S26). The resource for decode-and-forward relay is relayed in a decode-and-forward manner with an MCS for relay (Step S25), and the resource for amplify-and-forward relay is relayed in a decode-and-forward manner with the same MCS used for the received signal (Step S27).

As described above, the relay station according to the second embodiment determines whether there is a relay station that can perform decoding among the relay stations that perform cooperative relay, on the basis of the frequency resources allocated to other relay stations. The transmission resources allocated to each relay station are compared with the reception resources received by the relay station to determine whether there is a relay station that can perform decoding. When there is a relay station that cannot perform decoding, the relay station that can perform decoding relays the frequency resources relayed by the relay station that cannot perform decoding, using the MCS (Modulation and Coding Scheme) used by the relay station that cannot perform decoding to transmit signals, that is, the MCS used by the relay station to receive the relay signal from the mobile station.

In the relay station according to the second embodiment, the relay station that performs decode-and-forward relay can also transmit signals with the frequency resources used to relay and transmit signals in an amplify-and-forward manner. Therefore, a diversity effect is improved. In addition, it is possible to relay the frequency resources relayed by only the relay station that can perform decoding by changing the MCS.

In the relay station according to the second embodiment, the resources in which the signals cannot be received by all of the relay stations participating in cooperative relay can also be used for cooperative relay, and it is possible to reduce the scheduling load of the base station.

### Third Embodiment

In a third embodiment, a mobile station transmits a signal so that all relay stations participating in cooperative relay can decode the signal. The relay stations instruct the mobile station to use a transmission pattern indicating the arrangement of systematic bits and parity bits that can be decoded by all of the relay stations. The mobile station transmits signals in the transmission pattern instructed by the relay station. The relay station that instructs the mobile station to use the transmission pattern is predetermined. The relay station that does not instruct the transmission pattern also determines the transmission pattern of the mobile station according to the same rule as the relay station that instructs the transmission pattern and receives signals from the mobile station.

In the third embodiment, since all of the relay stations participating in cooperative relay can perform decoding, it is possible to improve the reception quality of relay signals.

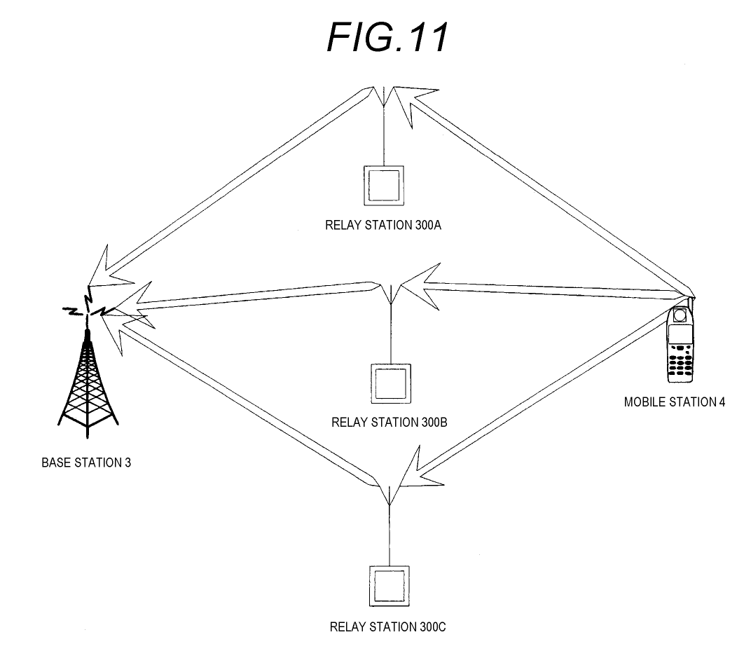

In the third embodiment, for example, a case in which relay stations 300A, 300B, and 300C participate in cooperative relay will be described. FIG. 11 schematically illustrates a cooperative relay system that cooperatively relays communication between a mobile station 4 and a base station 3 in the third embodiment.

In the cooperative relay system shown in FIG. 11, the relay stations 300A, 300B, and 300C cooperatively relay the communication between the mobile station 4 and the base station 3. The relay stations 300A, 300B, and 300C receive signals from the mobile station 4 and relay the received signals to the base station 3.

In the third embodiment, there are two kinds of transmission pattern instruction methods A and B of allowing each relay station to instruct the mobile station to use the transmission pattern. In the method A, the resources used for cooperative relay are divided, and a division number is determined so that decoding is possible for each divided resource. In the method B, a systematic bit is arranged in a common signal-receivable resource and a parity bit is arranged in the resource that cannot be commonly received.

(Method A)

In the method A, the relay station that instructs the mobile station to use the transmission pattern transmits a division number to the mobile station. When receiving the division number, the mobile station divides the frequency resources that are scheduled to be transmitted and encodes the divided frequency resources so that each of the frequency resources can be decoded. The relay station that instructs the division number determines the division number so that other relay stations participating in the cooperative relay can perform decoding. The transmission resource means a resource (for example, a frequency) allocated to transmit signals.

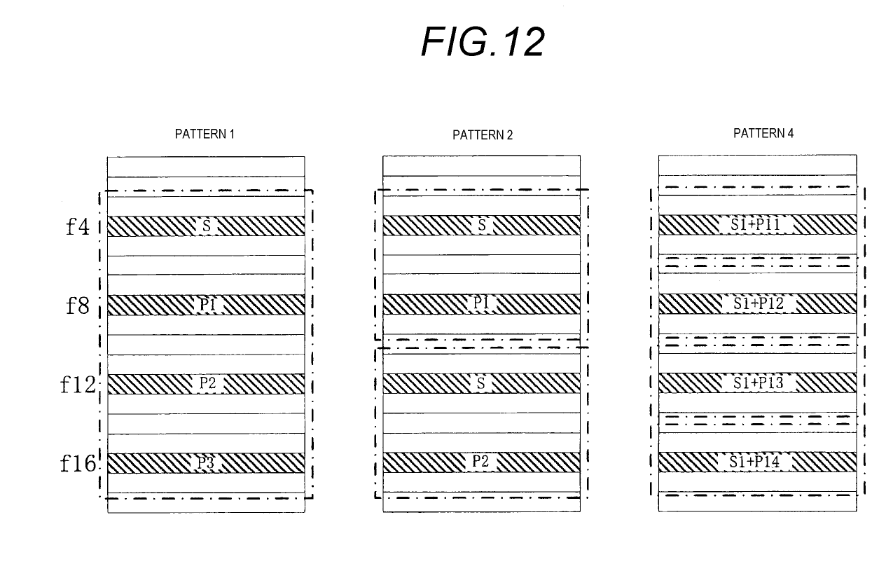

The transmission pattern based on the instruction method A will be described with reference to FIG. 12.

FIG. 12 shows an example of the division of resources based on the instruction method A. The frequency resources transmitted from the mobile station to the relay station are f4, f8, f12, and f16, similar to the first embodiment, and the relay station checks the resources that can be relayed by the relay stations participating in cooperative relay on the basis of scheduling information and relay station information, similar to the second embodiment, and determines the division number of the frequency resources.

In a transmission pattern 1 shown in FIG. 12, the resources are not divided. The transmission pattern 1 is used when all of the relay stations can relay all resources.

A systematic bit S and parity bits P1, P2, and P3 for correcting the systematic bit S are transmitted using the frequency resources f4, f8, f12, and f16. Since all of the relay stations can receive all resources, all of the relay stations decode and relay S.

In a transmission pattern 2 shown in FIG. 12, the resources are divided into two parts.

The transmission pattern 2 is used when the relay stations participating in cooperative relay can perform decoding with half a combination of the resources. The systematic bits S are arranged in the frequency resources f4 and f12. For the parity bits P1, P2, and P3, the parity bit P1 is transmitted using the frequency resource f8 and the parity bit P2 is transmitted using the frequency resource f16.

The relay station that cannot receive one of the frequency resources f12 and f16 or either of the frequency resources f12 and f16 receives only the frequency resources f4 and f8, decodes the systematic bit S with the parity bit P1, and relays the decoded bit. Similarly, the relay station that cannot receive the frequency resource f4 or f8, or either of the frequency resources f4 and f8 receives only the frequency resources f12 and f16, decodes the systematic bit S with the parity bit P2, and relays the decoded bit.

The relay station that cannot receive only the frequency resource f4 may decode the systematic bit S with both the parity bits P1 and P2. Similarly, the relay station that cannot receive only the frequency resource f12 may decode the systematic bit S with both the parity bits P1 and P2. As such, each relay station may decode signals using all signal-receivable resources.

The resources may be divided into three parts (transmission pattern 3) and then transmitted. A transmission method is the same as that in the pattern 2 and a description thereof will be omitted.

In a transmission pattern 4 shown in FIG. 12, all of the frequency resources are divided so that decoding is possible for each frequency resource.

That is, a systematic bit S1 and a parity bit P11 for decoding the systematic bit S1 are transmitted using the frequency resource f4. A systematic bit S1 and a parity bit P12 for decoding the systematic bit S1 are transmitted using the frequency resource f8. A systematic bit S1 and a parity bit P13 for decoding the systematic bit S1 are transmitted using the frequency resource f12. A systematic bit S1 and a parity bit P14 for decoding the systematic bit S1 are transmitted using the frequency resource f16.

The parity bits P11, P12, P13, and P14 are for correcting the errors of all of the systematic bits S1. Since different parity bits are transmitted using each frequency resource, it is possible to improve the error correction effect of the relay station that can receive a plurality of resources.

When different parity bits are transmitted using each frequency resource, each relay station can decode signals. Therefore, the relay station can correct errors and relay the error-corrected signals.

When the division number is instructed, it is possible to reduce the number of information bits, as compared to the configuration in which the arrangement of the systematic bit and the parity bit is instructed in detail. In addition, when different parity bits are transmitted for each divided signal, it is possible to improve an error correction effect.

In the method A, the relay station participating in cooperative relay calculates the division number using the same method as the relay station that instructs the mobile station on the division number. However, information of the division number instructed by the relay station may be added to the signal transmitted by the mobile station and then the signal may be transmitted.

In the method A, in the transmission pattern 1 shown in FIG. 12, the systematic bit S and the parity bit P may be interleaved and arranged in the frequency resources f4, f8, f12, and f16, and then transmitted.

In the method A, in the transmission pattern 2 shown in FIG. 12, the systematic bit S and the parity bit P1 may be interleaved between the frequency resources f4 and f8 and then transmitted. Similarly, the frequency resource f12 and the frequency resource f16 may be interleaved between the frequency resources f12 and f16.

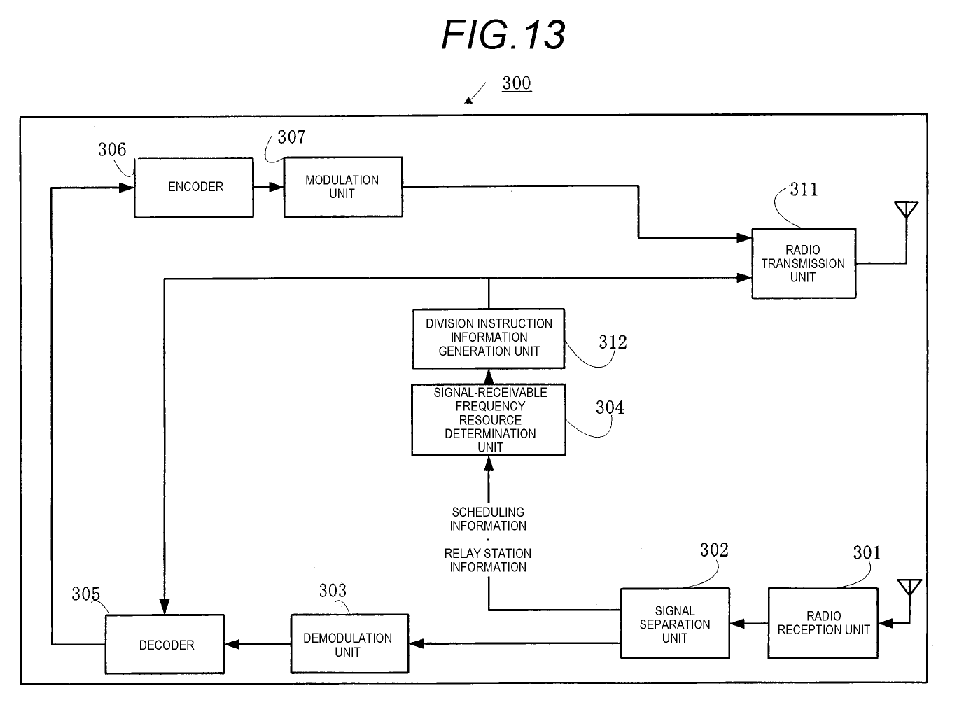

Next, the operation of the relay station according to the third embodiment will be described with reference to FIG. 13. FIG. 13 is a block diagram illustrating the relay station according to the third embodiment.

A relay station 300 includes a radio reception unit 301, a signal separation unit 302, a demodulation unit 303, a signal-receivable frequency resource determination unit 304, a decoder 305, an encoder 306, a modulation unit 307, a radio transmission unit 311, and a division instruction information generation unit 312.

The radio reception unit 301 receives a signal from the mobile station or the relay station through an antenna, performs radio processing, such as down-conversion, on the received signal, and outputs the processed signal to the signal separation unit 302.

The signal separation unit 302 separates the signal received from the mobile station or the relay station into a relay signal, relay station information, and scheduling information. The signal separation unit 302 inputs the relay signal to the demodulation unit 303 and inputs the relay station information and the scheduling information to the signal-receivable frequency resource determination unit 304.

The demodulation unit 303 demodulates the relay signal and outputs the demodulated relay signal to the decoder 305.

The signal-receivable frequency resource determination unit 304 determines the frequency that can be received by each relay station participating in cooperative relay on the basis of the scheduling information obtained from the signal separation unit 302 and outputs the determined frequency to the division instruction information generation unit 312.

The division instruction information generation unit 312 searches for the number of divisions where systematic bits can be transmitted so that they can be received by each relay station and selects the minimum division number among the division numbers where the systematic bits can be received. When the relay station including the division instruction information generation unit 312 transmits an instruction to the mobile station, the division instruction information generation unit 312 outputs division instruction information to the radio transmission unit 311. In addition, the division instruction information generation unit 312 outputs the division number to the decoder 305.

The decoder 305 divides and decodes the relay signal according to the division instruction information (including the division number) and outputs the decoded relay signal to the encoder 306.

The encoder 306 encodes the relay signal and outputs the encoded relay signal to the modulation unit 307.

The modulation unit 307 modulates the relay signal and outputs the modulated relay signal to the radio transmission unit 310.

Next, the operation of the mobile station according to the third embodiment will be described.

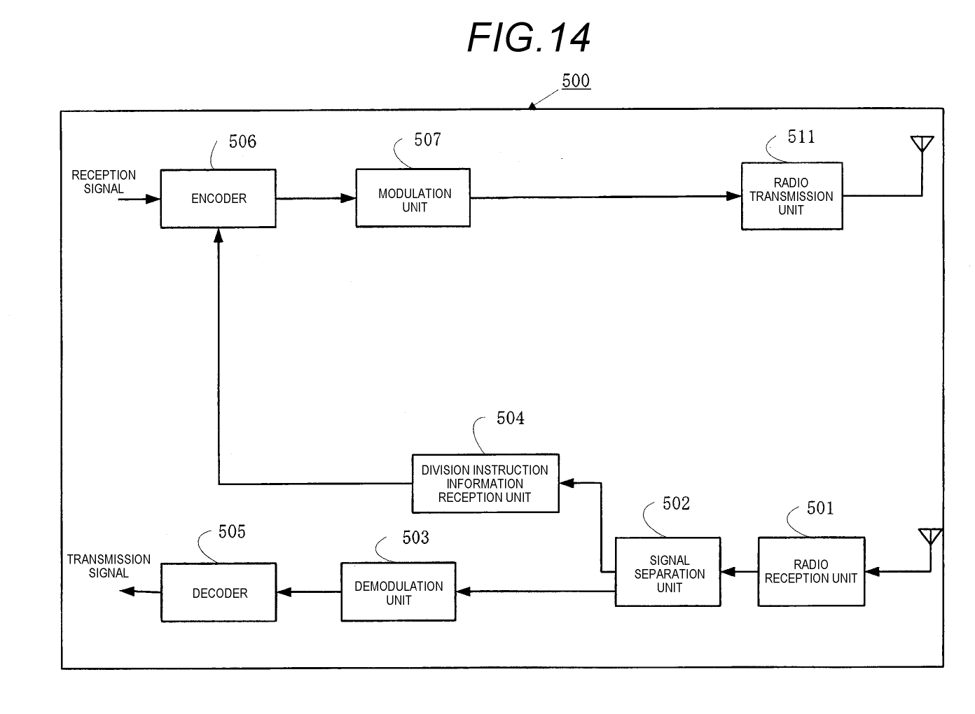

Next, the operation of the mobile station according to the third embodiment will be described with reference to FIG. 14.

FIG. 14 is a block diagram illustrating a mobile station 500 according to the third embodiment. In FIG. 14, a description of the same components as those in the block diagram of the relay station will be omitted.

The mobile station 500 according to the third embodiment includes a radio reception unit 501, a signal separation unit 502, a demodulation unit 503, a division instruction information reception unit 504, a decoder 505, an encoder 506, a modulation unit 507, and a radio transmission unit 511.

The radio reception unit 501 receives a signal from the relay station through an antenna, performs radio processing, such as down-conversion, on the received signal, and outputs the processed signal to the signal separation unit 502.

The signal separation unit 502 separates the signal input from the radio reception unit 501 into signal division instruction information and a received signal, outputs the division instruction information to the division instruction information reception unit 504, and outputs the received signal to the demodulation unit 503.

The division instruction information reception unit 504 outputs the instructed division number to the encoder 506. The encoder 506 encodes the transmission signal with the designated division number and outputs the signal to the modulation unit 507.

(Method B)

Next, the operation of the relay stations 300A, 300B, and 300C that perform cooperative relay on the basis of the transmission pattern instruction method B will be described. As shown in FIG. 11, in the cooperative relay system according to the third embodiment, the relay stations 300A, 300B, and 300C cooperatively relay the communication between the mobile station 4 and the base station 3. The relay stations 300A, 300B, and 300C receive signals from the mobile station 4 and relay the received signals to the base station 3. It is assumed that the frequency resources transmitted by the mobile station 4 are f4, f8, f12, and f16.

In the transmission pattern instruction method B, systematic bits are arranged in the frequency resources that can be received by all of the relay stations 300A, 300B, and 300C participating in cooperative relay.

Therefore, since all of the relay stations 300A, 300B, and 300C can receive the systematic bits and decode the received systematic bits, each relay station can correct errors.

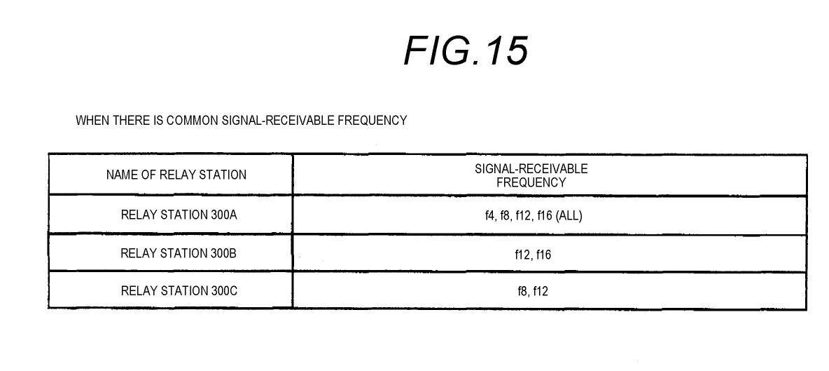

FIG. 15 shows an example of the frequency that can be received by each relay station. As shown in FIG. 15, the relay station 300A can receive all frequencies, the relay station 300B can receive the frequencies f12 and f16, and the relay station 300C can receive the frequencies f8 and f12. Therefore, the common frequency that can be received by all of the relay stations 300A, 300B, and 300C is f12. The relay stations instruct the mobile station 4 to transmit the systematic bit at the common frequency f12 that can be received by the relay stations. The relay station issuing the instruction may be predetermined.

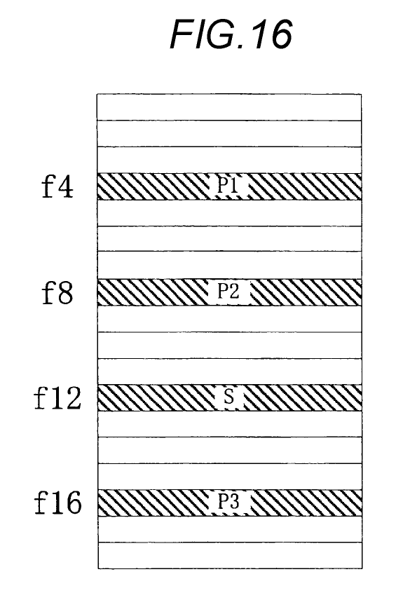

FIG. 16 shows an example of the division of the frequency resources in the mobile station.

As described above, the mobile station 4 receives an instruction to transmit the systematic bit at the common signal-receivable frequency f12 from a predetermined relay station. Therefore, as shown in FIG. 16, the mobile station 4 receiving the instruction from the predetermined relay station 300A arranges the systematic bit S in the frequency resource f12, and transmits parity bits to the other frequency resources f4, f8, and f16.

When there is a plurality of common frequencies that can be received by a plurality of relay stations, a predetermined relay station instructs the mobile station 4 to arrange the systematic bits to be distributed.

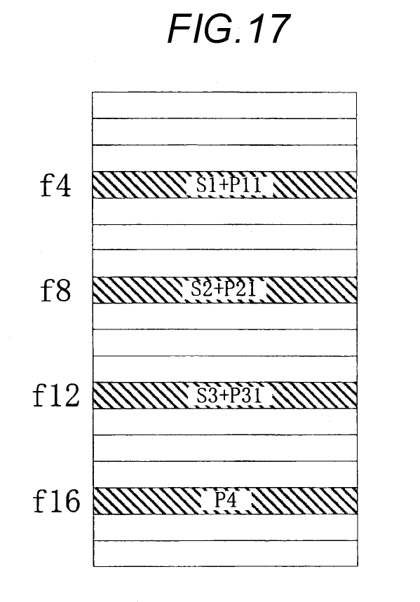

For example, FIG. 17 shows an example of the division of the frequency resources in the mobile station when the frequency resources f4, f8, and f12 are a plurality of frequencies that can be commonly received by the relay stations. The mobile station divides the systematic bit S into S1, S2, and S3, and arranges the divided systematic bits in the frequency resources f4, f8, and f12 together with different parity bits P11, P21, and P31. S1 and P11 are transmitted to the frequency resource f4, S2 and P21 are transmitted to the frequency resource f8, and S3 and P31 are transmitted to the frequency resource f12.

A parity bit P4 is transmitted to the frequency resource f16 where there is a relay station that cannot receive the frequency. The parity bits P11, P21, P31, and P4 are divided from the parity bit for the systematic bit_S.

When there is no common frequency that can be received by a plurality of relay stations, a frequency resource that allows the number of relay stations to be larger is selected and the systematic bit is transmitted. The systematic bit is transmitted to the frequency resource in which the signal can be received by the relay station which cannot receive the selected frequency resource. In addition, the relay station that has a small signal-receivable frequency resource and for which it is difficult to receive all systematic bits receives some of the systematic bits and partially participates in the relay of signals to the base station.

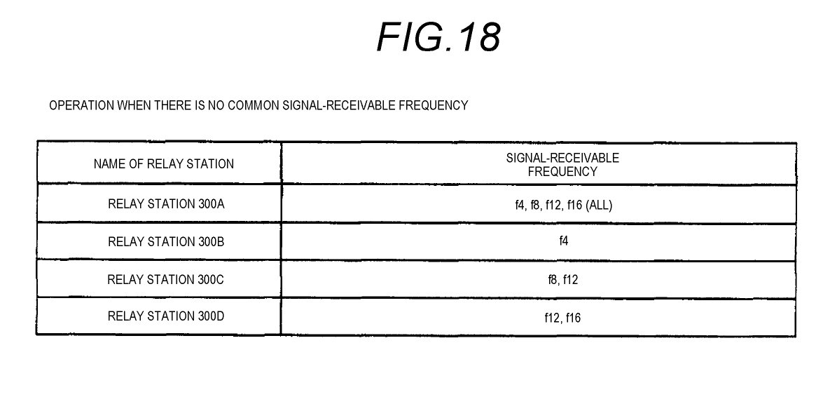

FIG. 18 shows an example of the frequency that can be received by each relay station when there is no common frequency that can be received by a plurality of relay stations. As shown in FIG. 18, it is assumed that the relay station 300A can receive all frequencies, the relay station 300B can receive the frequency f4, the relay station 300C can receive the frequencies F8 and F12, and the relay station 300D can receive the frequencies F12 and F16. In this case, there is no common frequency that can be received by four relay stations.

As shown in FIG. 18, the frequency resource f12 can be commonly received by the largest number of relay stations. The frequency resource f12 can be received by the relay stations 300A, 300C, and 300D.

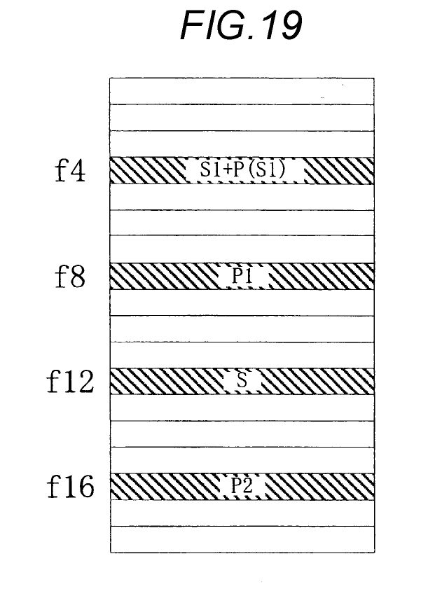

FIG. 19 shows an example of the division of the frequency resource in the mobile station 4. As shown in FIG. 19, the mobile station 4 receives an instruction to transmit the systematic bit S to the frequency resource f12 from a predetermined relay station, and arranges the systematic bit S in the frequency resource f12.

Since the relay station 300B can receive only the frequency resource f4 as shown in FIG. 18, the relay station 300B instructs the mobile station to transmit a portion S1 of the systematic bit and a parity bit P(S1) for correcting S1 to the frequency resource f4 so that decoding can be performed in the frequency resource f4.

In addition, the relay station 300B instructs the mobile station to transmit P1 and P2, which are the parity bits of the systematic bit S, to the remaining frequency resources f8 and f16.

As shown in FIG. 18, since the relay station 300B can receive only the systematic bit S1, the relay station 300B participates in cooperative relay using only the portion S1 during relay.

The other relay stations 300A, 300C, and 300D generate S1 from S and participate in cooperative relay for all signals.

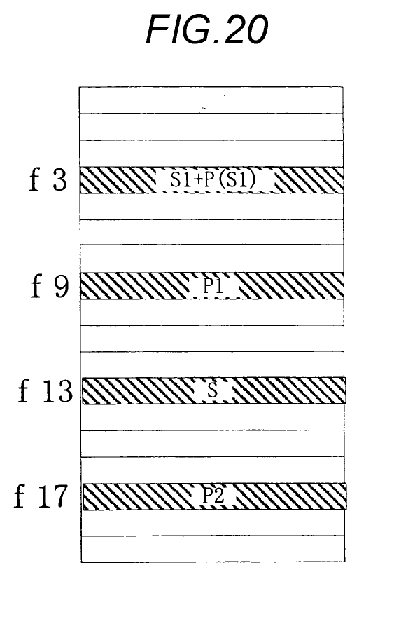

FIG. 20 shows an example of the transmission operation of the relay station. It is assumed that the transmission frequency resources that are allocated for transmission from the relay station to the base station are f3, f9, f13, and f17. In addition, it is assumed that S1+P(S1) is allocated to the frequency resource f3, P1 is allocated to the frequency resource f9, S is allocated to the frequency resource f13, and P2 is allocated to the frequency resource f15. S1 and P(S1) allocated to the frequency resource f3 are the same as that received by the relay station with f4.

As described above, the relay station 300B can receive only the systematic bit S1, but cannot receive the systematic bit S. Therefore, the relay station 300B participates in cooperative relay using only the frequency resource f3 that relates the systematic bit S1 and the parity bit P(S1). On the other hand, since the other relay stations 300A, 300C, and 300D can receive the systematic bit S, they encode the systematic bit again, generate the parity bits P1 and P2, and relay signals using the frequency resources f9, f13, and f17. In addition, the relay stations 300A, 300C, and 300D generate the systematic bit S1 from the systematic bit S and participate in the relay of S1+P(S1) of the frequency resource f3. In this way, even when there is no common signal-receivable frequency, all of the relay stations 300A, 300B, 300C, and 300D can participate in cooperative relay.

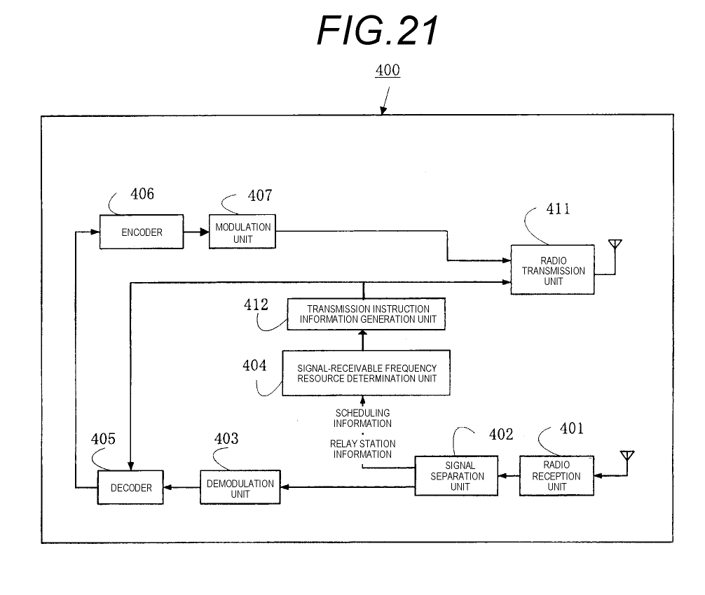

Next, the operation of the relay station based on the transmission pattern instruction method B will be described. FIG. 21 is a block diagram illustrating the relay station based on the transmission pattern instruction method B. A description of the same portions as those in the method A will be omitted.

A radio reception unit 401 receives a signal from the mobile station or the relay station through an antenna, performs radio processing, such as down-conversion, on the received signal, and outputs the processed signal to a signal separation unit 402.

The signal separation unit 402 separates the signal received from the mobile station or the relay station into a relay signal, relay station information, and scheduling information. The signal separation unit 402 inputs the relay signal to the demodulation unit 403 and inputs the relay station information and the scheduling information to a signal-receivable frequency resource determination unit 404.

The signal-receivable frequency resource determination unit 404 determines a common frequency that can be received by the relay stations participating in cooperative relay on the basis of the scheduling information and the relay station information obtained from the signal separation unit 402, and outputs the determination result to a division instruction information generation unit 412.

The transmission instruction information generation unit 412 selects a common frequency that can be received by the relay stations participating in cooperative relay on the basis of the determination result of the signal-receivable frequency resource determination unit 404. Then, the transmission instruction information generation unit 412 generates a signal for instructing the mobile station to transmit a systematic bit at the common frequency that can be received by the relay stations participating in cooperative relay. The instruction signal is also output to a decoder 405. The relay station that transmits the instruction to the mobile station outputs instruction information to the radio transmission unit 411.

The demodulation unit 403 decodes the relay signal separated by the signal separation unit 402 and outputs the decoded signal to the decoder 405.

The decoder 405 estimates the arrangement of the systematic bit and the parity bit on the basis of information input from the transmission instruction information generation unit 412 and decodes the relay signal.

An encoder 406 encodes the relay signal and outputs the encoded relay signal to a modulation unit 407.

The modulation unit 407 modulates the relay signal and outputs the modulated relay signal to a radio transmission unit 410.

The relay station according to each of the above-described embodiments is also represented by a relay station, a repeater, a simple base station, or a cluster head.

In each of the above-described embodiments, uplink transmission is given as an example, but the invention can be similarly applied to downlink transmission in which the base station and the mobile station are reversed.

The relay station according to each of the above-described embodiments may be a fixedly-located relay station or a moving relay station.

Each functional block in each of the above-described embodiments is typically implemented by an LSI, which is an integrated circuit. Each of the functional blocks is manufactured as one chip or some or all of the functional blocks are incorporated into one chip. Here, each functional block is an LSI, but it is also called an IC, a system LSI, a super LSI, or an ultra LSI according to the degree of integration.

An integrated circuit manufacturing method is not limited to the LSI, but it may be implemented by a dedicated circuit or a general-purpose processor. After the LSI is manufactured, a programmable FPGA (Field Programmable Gate Array) or a reconfigurable process capable of reconfiguring the connection or setting of circuit cells in the LSI may be used.

When a circuit integration technique capable of substituting the LSI appears with the progress of a semiconductor technique or by other derivative techniques, the technique may be used to integrate the functional blocks. For example, biotechnology can be applied.

In the above-described embodiments, the antenna is given as an example, but the invention can be similarly applied to an antenna port. The antenna port means a logical antenna including one physical antenna or a plurality of physical antennas. That is, the antenna port does not necessarily indicate one physical antenna, but may indicate an array antenna including a plurality of antennas. For example, in LTE, the number of physical antennas included in the antenna port is not defined, but the antenna port is defined as the minimum unit that enables the base station to transmit different reference signals. In addition, the antenna port may be defined as the minimum unit of multiplication of the weights of precoding vectors.

The invention has been described in detail with reference to specific embodiments, but it will be understood by those skilled in the art that various modifications and changes of the invention can be made without departing from the scope and spirit of the invention.

This application is based on Japanese Patent Application No. 2008-160754, filed Jun. 19, 2008, the content of which is incorporated herein by reference.

### INDUSTRIAL APPLICABILITY

According to the radio communication device of the invention, the resources in which the signals cannot be received by all of the relay stations participating in cooperative relay can be used for cooperative relay. Therefore, the invention is useful for a radio communication device.

### REFERENCE SIGNS LIST

100, 100A, 100B: Relay Station

200, 200A, 200B, 200C: Relay Station

300, 300A, 300B, 300C, 300D: Relay Station

400, 900A: Relay Station

3, 500, 803, 903: Base Station

4, 804, 904: Mobile Station

101, 201, 301: Radio Reception Unit

102, 202, 303: Signal Separation Unit

103, 203: Demodulation Unit

104, 204, 304: Signal-Receivable Frequency Resource Determination Unit

105, 205, 305: Decoder

106, 206A, 206B, 306: Encoder

107, 207A, 207B, 307: Modulation Unit

108: Amplify-And-Forward Signal Reception Processing Unit

109, 209: Amplifying Unit

110: Transmission Selection Unit

111, 211, 311: Radio Transmission Unit

208: Amplify-And-Forward Signal Reception Processing Unit

210: Transmission Resource Allocation Unit

312: Division Instruction Information Generation Unit

1. A radio communication device that relays radio communication, comprising:
a determination unit that determines a signal-receivable resource indicating a resource in which a signal can be received, from resources used for cooperative relay based on scheduling information; and
a selection unit that selects a radio communication relay method based on a determination result of the determination unit.

2. The radio communication device according to claim 1, wherein
the determination unit determines whether the signal in the signal-receivable resource can be decoded by the radio communication device, and
the selection unit selects a decode-and-forward relay as the radio communication relay method when the signal in the signal-receivable resource can be decoded by the radio communication device and selects an amplify-and-forward relay as the radio communication relay method when the signal in the signal-receivable resource cannot be decoded by the radio communication device.

3. The radio communication device according to claim 1, wherein,
based on relay station information for specifying another radio communication device that relays the radio communication, in addition to the scheduling information, the determination unit determines whether the other specified radio communication device can decode the signal in the signal-receivable resource, and
the selection unit selects, as the radio communication relay method, a method of relaying the radio communication with the same MCS used for a resource, which the other radio communication device that cannot decode the signal-receivable resource uses for the cooperative relay, based on a determination result of the determination unit.

4. The radio communication device according to claim 3, wherein
a relay signal contained in a resource in which a signal is not transmitted by the other radio communication device performing an amplify-and-forward relay among the signal-receivable resources is relayed with an MCS converted for relay transmission of the radio communication.

5. A radio communication device that communicates with another radio communication device using a cooperative relay between relay stations, wherein
transmission signal that is to be transmitted to the other radio communication device through the relay stations performing the cooperative relay is allocated to each of the relay stations so that all of the relay stations can decode the transmission signal.

6. The radio communication device according to claim 5, wherein
resources for the transmission signal allocated to each of the relay stations in order to perform the cooperative relay are divided so that all of the relay stations can decode the transmission signal.

7. The radio communication device according to claim 5, wherein
a systematic bit is transmitted using a resource that can be commonly received by each of the relay stations among the resources for the transmission signal allocated to each of the relay stations in order to perform the cooperative relay, and
a parity bit is transmitted using a resource that cannot be commonly received by each of the relay stations.

8. The radio communication device according to claim 5, wherein,
when signals in the resources for the transmission signal allocated to each of the relay stations in order to perform the cooperative relay cannot be commonly received by each of the relay stations, the transmission signal is allocated to each of the relay stations so that the transmission signal can be decoded using one of the resources.
